(19) United States
(12) Patent Application Publication
(10) Pub. No.: US 2008/0075814 A1
(43) Pub. Date: Mar. 27, 2008

(54) Emergency food packaging

(76) Inventor: Jeffrey J. Rinz, Bonita Springs, FL (US)

Correspondence Address: QUARLES & BRADY LLP, 411 E. WISCONSIN AVENUE, SUITE 2040, MILWAUKEE, WI, 53202-4497, US

(21) Appl. No.: 11/525,771

(22) Filed: Sep. 25, 2006

(51) Int. Cl. A23B 7/148

(52) U.S. Cl. 426/106

(57) ABSTRACT

A storm pack designed to be used in emergency situation such as hurricanes, earthquakes and/or tsunamis. The storm pack consists a main pouch that can be hermetically sealed from the environment. The is a plastic zipper that will allow entry into the interior of the main pouch. There is a multiple of inner pouches that are to be stored within the main pouch. About half of the multiple of the inner pouches will have water stored therein and the other half will receive a diversity of food items therein. The multiple of the inner pouches themselves are hermetically sealed from the ambient environment. Once the multiple of inner pouches are nestled within the main pouch and the main pouch is sealed, the water and the food items may be stored for years but will be ready for use for an emergency use.

### BACKGROUND OF THE INVENTION

Many attempts have been made to prepackage food items to be available at emergency situations such as hurricanes, fire storms or tsunamis. There are MRS (Meals Ready to Eat) that are designed for the military use wherein the meals are ready cooked and moist. The food contained in these pouches are known to be in flexible cans consisting of flexible aluminum as retort pouches that are used in MRE pouched food products and are composed of multiple aluminum foil and plastic film which exhibit rugged durability, extended shelf life and ease of stowing. There are other emergency food and water packaged in boxes, whereby there will be enough food and water available for each person stored in a 72 hr. kit. Such kits are frozen and include house freeze dried food. These freeze dried foods and water are supplied in convenient stand-up pouches that are perfect to store 72 hour kits in a backpack for camping and boating on weekends and camping in getaways for just one night.

### BRIEF DESCRIPTION OF THE INVENTION

Our concept known as storm pack offers a new concept in shelf stable foods; naturally prepared with no preservations or chemicals and ready-to-eat food and water in a convenient, flexible hand held pouch for emergency and survival situations. The emergency relief food pack is there to help for anyone to recover from any sudden or unexpected emergency situation. Each Storm Pack kit or pouch contains an equal number of a multiple of supplementary emergency food rations in a full menu format. Each Storm Pack contains an equal number of drinking water pouches and 8 pouches of meal food portions. This represents complete pouched meals per kit. Each master pouch kit contains 8 water+8 pouched meal food portion which equals 16 total pouch portions or 8 complete multi-meal food and water kit providing all ration needs for 1 to 2 persons per day.

Every pouch can be opened very easily by hand through side tear notches, (no implements are required). The pouches can be heated in boiling water, be prepared in a microwave, in the sun, or the food can be eaten directly out of a pouch at room temperature.

flexible hand held pouches are provided for emergency and survival situations. The tasty foods require no refrigeration and can be kept at room temperatures for up to 2 years.

### BRIEF DESCRIPTION OF THE DRAWINGS

FIG. 1 is a frontal view of the main food pouch or bag;

FIG. 2 is a side view of the main pouch including the two side walls;

FIG. 3 is a front view of the main pouch including the location of sealable plastic zippers;

FIGS. 4a-c illustrates the progressive closure of the zipper;

FIG. 5 shows a break-away front of the main pouch exposing the location of the zipper and the top of the adhesive closure;

FIG. 5A illustrates on way of stacking the small pouches in a main pouch;

FIG. 6 shows a perspective view of a small food pouch;

FIG. 7 is a front view of the small food pouch of FIG. 6;

FIG. 8 is a plan view of the small pouch prior to assembly.

### DETAILED DESCRIPTION OF THE INVENTION

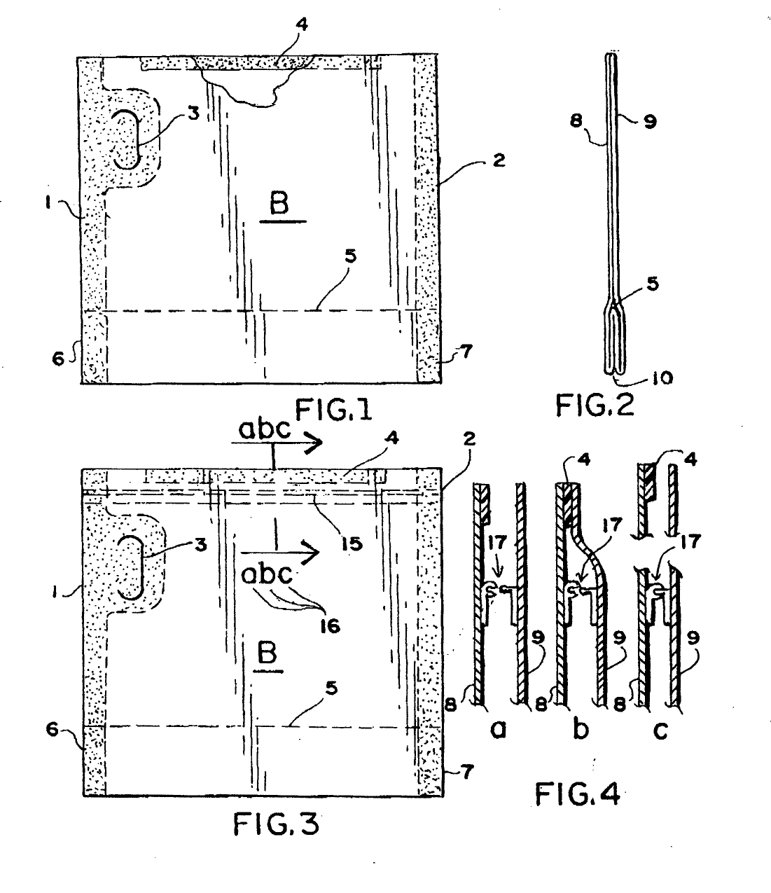

Turning now to FIG. 1, there is shown a frontal representation of the main food bag or pouch B which consist of two layers shown in FIG. 2 as 8 and 9. The food bag B has left and right edges 1 and 2 which are sealed together either by heat sealing or by adhesives. At the lower end of the main bag B and at the edges thereof there are two sections 6 an 7 which not sealed together or attached to each other. This leaves a space of about 2 inches where the side walls 8 and 9 are not connected to each other at 10 (FIG. 2). The reason for this open space 10 is to enable the bag to be opened at its bottom to form an elliptical and open space, whereby the bag can stand on its own in an upright position. At the bottom of the Bag B there is a connecting line 5 that limits the interior of the bag B at that line and forms the bottom of the bag B.

FIG. 3 shows the main bag B in a frontal view and shows at its top the upper edge sealant 4. This sealant is closed when the main Bag B has been filled with the small food bags (to be described below). Once the upper edge has been sealed by the adhesive strip 4, the main food bag B is accessible by way of the zipper 15 located just below the sealed upper edge. The letters a-c shown at 16 in FIG. 3 show the various stages of the zipper operation of the zipper 15.

FIG. 4 shows the various zipper operational stages as shown by a, b, c. The space between the opposing parts of the zipper is shown at 17 and shows the various stages of the zipper operation. At 4 is shown the upper seal of the bag B in an open or closed position. 8 and 9 illustrate the panels that make up the bag B. Also shown in FIG. 3 is the outline of a handle that may pressed out of the panels 8 and 9 to be used to carry the main Food bag B or to suspend the bag B in a convenient location.

FIGS. 5 and 5A illustrate the main Bag B in its filled condition as can be seen by the broken away opening. The same reference characters are displayed as were used in previous Figs. The exposed opening shows the small bags 20 in a stacked position. The stacking is only shown as one way of doing it, but many different ways may be used to accomplish the same result. Instead of a vertical position, the bags 20 could be positioned in a horizontal position just as well and positioned within each other.

FIG. 6 illustrates the small food bag F in a perspective view. The food bag F has side edges 25 and 26 and has a transparent bottom through the content 27 of the food F can be seen. At each side edge 25 and 26 there are notches that can be used to tear open the small food bag F when the food inside the bag F is ready to be consumed.

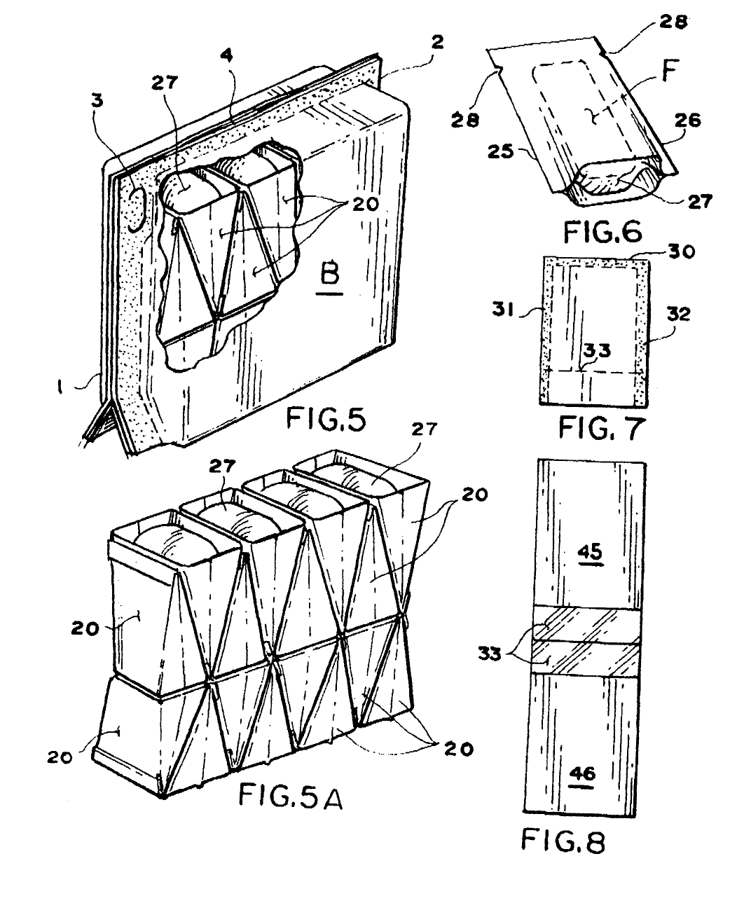

FIG. 7 shows the small food bag F in a planar layout. There are three side edges 30, 31, and 32 which are heat sealed to form a bag. the bottom of the bag is sealed at 33 just where the transparent panel is locate. This forms a bottom recess when opened to be able to view the food 27 as shown in FIG. 6.

FIG. 8 shows a plan view of the small pouch in a lay out prior to constructing the same. There are two side walls 45 and 46 having the see through panel 27 (FIG. 6) connecting the same at the bottom.

### Material and Dimensions of the Bags

### Outer Pouch for the Storm Pack—133 Ounces

### Releasable heavy duty Zipper at top;

tear notches above Zipper at left and right edges;
48 gage/PET adhesive/mil adhesive—8 color dimensions;
14″ tall×14″×6″ BG

### Inner Pouch for Storm Pack 8 oz.—Food

### Retortable & microwave able laminate;

48 gage/PET/ink—8 colors/60 gage glass coated;

### Biax nylon/adhesive 3 mil CPP;

5″ wide×3.0″ BG (clear)×7.52″ high.

### Inner Pouch for Storm Pack 8 oz—Water;

### Retortable & microwave able laminate;

48 gage/PET/ink—8 colors/60 gage glass coated;

### Biax nylon/adhesive 3 mil CPP;

5′ wide×3.0 BG (clear)×7.52″ high.

The outer main bag of the storm pack should show a printed identification as to what is stored in the inner food packs by way of identifying the type of food contained therein. The inner bags should identify the food item contained therein by name and by way of nutrition facts such calories, cholesterol, sodium ect.

1. A pack comprising: an outer main pouch and a plurality of inner pouches, said outer main pouch having outer panels to form said outer main pouch and said outer main pouch having an upper sealant to close said outer panels at an upper end and said outer main pouch having a plastic zipper below said upper sealant, sides of said outer panels being heat sealed together except for a distance at a bottom of said main pouch leaving a free section, said outer main pouch having a closure across said bottom at said free section of said outer main pouch to create a sealed bottom, said free section when opened creating an elliptical structure to aid in said outer main pouch to assume an upstanding position, said plurality of inner pouches being placed within said outer main pouch by way of said zipper when said zipper is in an open position, whereby, when said zipper is closed, an interior of said outer main pouch is hermetically sealed from exterior environment.

2. The pack of claim 1, wherein a first number of said inner pouches contains water and a second number of said inner pouches contains food.

3. The pack of claim 2, wherein said first number equals said second number.

4. The pack of claim I including perforations in an upper corner of said outer main pouch so handle section may broken out from said panels of said outer main pouch to form a hand hold aperture.

5. The pack of claim 1 including tear notches located above said zipper at left and right corners such that the tear notches may be used to tear the upper end of said outer main pouch apart.

6. The pack of claim 1, wherein material used to form said main pouch is PET.

7. The pack of claim 1, where at least one inner pouch is sealed at two sides with the bottom side being sealed with a see-through panel, allowing said at least one inner pouch to assume an upright and three dimensional position.

8. The pack of claim 1 including tear notches located at top left and right sides of said outer main pouch.

9. The pack of claim 2, where material used to form said inner pouches containing food is a retortable and microwaveable material.

10. The pack of claim 2, where material use to form said inner pouches containing water is a retortable and microwaveable laminate.

11. The pack of claim 6 wherein the material is PET.

12. The pack of claim 9 wherein the material is PET.

13. The pack of claim 10 wherein the laminate includes PET and nylon.

14. The pack of claim 10 wherein the laminate is 48 gage PET including a 60 gage glass coated biax nylon.

15. The pack of claim 1 wherein the inner pouches have triangular side panels with an apex, and the inner pouches are placed within said outer main pouch with the apex of each adjacent inner pouch facing in an opposite direction.

16. The pack of claim 1, wherein material used to form said outer main pouch is flexible.

17. The pack of claim 2, wherein the inner pouches are shelf stable when kept at room temperature for up to two years.

18. The pack of claim 1, wherein the upper sealant comprises an adhesive strip.

19. The pack of claim 1, wherein material used to form said inner pouches is flexible.

20. The pack of claim 1, eight inner pouches contain water and eight inner pouches contain food.
